(19) United States
(12) Patent Application Publication
(10) Pub. No.: US 2026/0228512 A1
(43) Pub. Date: Aug. 6, 2026

(54) DYNAMIC TRANSFORMER LAYERS

(71) Applicant: INTUIT INC., Mountain View, CA (US)

(72) Inventors: Matan VETZLER, Tel Aviv (IL); Shai ARDAZI, Tel Aviv (IL); Kfir AHARON, Tel Aviv (IL); Linoy COHEN, Tel Aviv (IL)

(73) Assignee: INTUIT INC., Mountain View, CA (US)

(21) Appl. No.: 19/043,046

(22) Filed: Jan. 31, 2025

(51) Int. Cl. G06N 3/0495; G06N 3/091

(52) U.S. Cl. CPC G06N 3/0495; G06N 3/091

(57) ABSTRACT

A system and method for dynamic layer quantization in large language models (LLMs) is described. A classifier predicts quantization levels for LLM layers based on input data and current layer output. The system applies these predicted levels to subsequent layers, allowing efficient LLM operation across various devices. This approach may help balance performance and resource use. The system can use federated learning to improve both the LLM and the classifier, potentially adapting better to different devices and uses.

### BACKGROUND

Large language models (LLMs) have become increasingly prevalent in various applications, from natural language processing to complex decision-making systems. As the demand for deploying LLMs in diverse environments grows, researchers and practitioners have explored various techniques to optimize their performance and efficiency, including model compression, quantization, and adaptive inference strategies.

Despite the advancements in LLM optimization, existing approaches often face limitations in balancing model accuracy and computational efficiency. Static quantization methods, while reducing model size and inference time, may lead to significant performance degradation for tasks or input types. Current solutions often fail to adequately address the diverse computational capabilities of different devices or the varying complexity of input queries, resulting in suboptimal resource utilization and user experience across heterogeneous deployment scenarios.

### SUMMARY

Embodiments disclosed herein solve the aforementioned technical problems and may provide other technical solutions as well. Contrary to conventional techniques, the disclosed solution includes a novel method and system for implementing dynamic transform layer quantization for an LLM.

An example embodiment includes a method for dynamic layer quantization in a language model comprising receiving at a classifier query data from a user device and output data from a current layer of an LLM, predicting by the classifier a quantization level for a subsequent layer of the LLM based on the query data from the user device and output data from the current layer of the LLM, selecting by the classifier the predicted quantization level for the subsequent layer of the LLM, processing by the LLM the output data of from the current layer of the LLM through the quantized subsequent layer of the LLM, and outputting by the LLM a response to the user query.

An example embodiment includes a system for dynamic layer quantization in a language model comprising a classifier configured to receive query data from a user device and output data from a current layer of an LLM, predict a quantization level for a subsequent layer of the LLM based on the query data from the user device and output data from the current layer of the LLM, select the predicted quantization level for the subsequent layer of the LLM, the LLM configured to process the output data from the current layer of the LLM through the quantized subsequent layer of the LLM, and output a response to the user query.

### BRIEF DESCRIPTION OF THE DRAWINGS

So that the present disclosure can be understood in detail, a more particular description of the disclosure, briefly summarized above, may be made by reference to example embodiments, some of which are illustrated in the appended drawings. It is to be noted, however, that the appended drawings illustrate only example embodiments of this disclosure and are therefore not to be considered limiting of its scope, for the disclosure may apply to other equally effective example embodiments.

FIG. 1 illustrates a system for dynamic layer quantization in a network environment, according to aspects of the present disclosure.

FIG. 2A illustrates a block diagram of a system for dynamic layer quantization of a large language model, according to aspects of the present disclosure.

FIG. 2B illustrates layers of an LLM for dynamic layer quantization, according to aspects of the present disclosure.

FIG. 3 illustrates a flowchart of a method for training a classifier to predict quantization levels, according to aspects of the present disclosure.

FIG. 4 illustrates a flowchart of a method for dynamic layer quantization in a large language model, according to aspects of the present disclosure.

FIG. 5 illustrates a flowchart of a method for dynamic quantization adjustment, according to aspects of the present disclosure.

FIG. 6 illustrates a flowchart of a method for implementing a federated learning process with dynamic quantization, according to aspects of the present disclosure.

FIG. 7 illustrates a flowchart of a method for multi-classifier quantization processing, according to aspects of the present disclosure.

FIG. 8 illustrates a block diagram of a computing system, according to aspects of the present disclosure.

### DETAILED DESCRIPTION OF SEVERAL EMBODIMENTS

The present disclosure relates to systems and methods for dynamic layer quantization in LLMs. Dynamic layer quantization may allow for efficient deployment of LLMs on devices with varying computational capabilities while maintaining model performance. This approach may adapt the precision levels for each layer of the LLM during inference, potentially optimizing resource utilization and reducing latency.

In some cases, the system may include adapters added to each layer of the LLM. These adapters may analyze input and hidden representations to determine the appropriate quantization level for subsequent layers. By dynamically adjusting quantization levels, the system may balance computational efficiency and model accuracy on a per-layer basis.

The system may also incorporate a precision injection mechanism. This mechanism may allow for dynamic loading of layers in the beneficial precision format during inference. Such an approach may enable fine-grained control over model precision, potentially adapting to changing computational resources or task complexities in real-time.

One potential benefit of dynamic layer quantization may be improved efficiency in deploying LLMs across a wide range of devices. By adapting quantization levels to device capabilities and workload, the system may optimize performance on both high-end and resource-constrained devices. This adaptability may lead to reduced latency and lower memory requirements without significant loss in model accuracy.

Another potential advantage may be the system's ability to handle varying task complexities. For instance, simpler language processing tasks may require lower precision in layers, while more complex tasks may benefit from higher precision. Dynamic layer quantization may allow the system to adjust precision levels based on the specific requirements of each task, potentially improving overall efficiency.

In some implementations, the LLM may be hosted on a separate server. This configuration may allow for centralized processing of queries, potentially leveraging more powerful computational resources for complex language tasks. By hosting the LLM on a dedicated server, the system may be able to handle multiple user queries simultaneously, distribute the computational load across specialized hardware, and potentially provide faster response times. This centralized approach may facilitate easier updates and maintenance of the LLM, as changes can be made to a single instance rather than updating multiple distributed copies. The server hosting the LLM may also be equipped with specialized hardware accelerators, such as GPUs or TPUs, which can significantly speed up the processing of language tasks. This centralized configuration may enable more efficient resource allocation, allowing the system to dynamically scale computational resources based on demand.

The system may also accommodate scenarios where portions or the entirety of the LLM could be executed on the user device itself, potentially enabling more responsive and privacy-preserving interactions in contexts. The dynamic quantization approach outlined in the patent may be particularly beneficial in scenarios where at least some LLM processing occurs on the user device. For instance, in a partial on-device execution scenario, some layers of the LLM may be processed locally on the user device, while more computationally intensive layers may be handled by a remote server. In cases where the user device possesses sufficient computational power, the entire LLM may potentially run on the device itself. In these scenarios, the system may adjust the precision of LLM layers based on the specific capabilities of the device and the complexity of the current task, potentially optimizing performance and resource utilization. This flexibility may allow the system to balance factors such as processing speed, energy efficiency, and model accuracy across a wide range of deployment contexts.

As a real-world example, consider a virtual assistant application running on various smartphone models. The application may utilize an LLM for natural language understanding and generation. On a high-end smartphone with ample computational resources, the system may use higher precision levels for many layers, potentially maximizing accuracy. Conversely, on an older or budget smartphone with limited resources, the system may dynamically reduce precision for layers, allowing the LLM to run efficiently without significant performance degradation. As the user interacts with the virtual assistant, the system may continuously adjust layer quantization based on the complexity of the queries and available device resources, potentially providing a responsive and adaptive user experience across diverse hardware configurations.

The present disclosure relates to a system and method for dynamic layer quantization in LLMs. This innovative approach may significantly enhance the efficiency of LLM deployment and operation, particularly in scenarios with limited computational resources or where rapid adaptation to new data is beneficial. By dynamically adjusting the precision of different layers within the LLM, the system may optimize performance while reducing latency and resource usage.

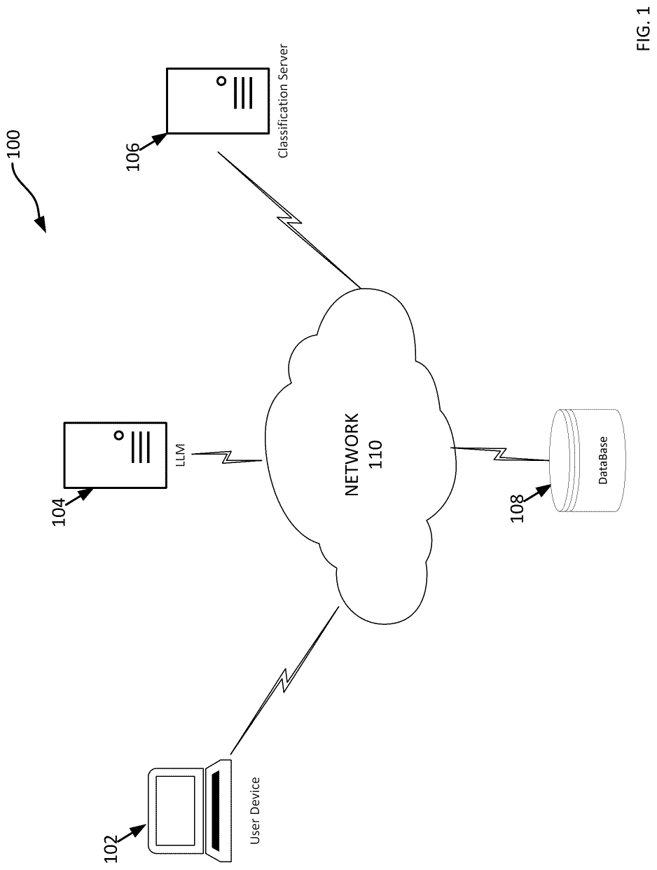

FIG. 1 illustrates a system 100 for dynamic layer quantization in a network environment. The system 100 may comprise several interconnected components communicating through a network 110. A user device 102, such as a smartphone or laptop, may be connected to the network 110. The network 110 may also connect to LLM 104, which may be implemented on a high-performance server or distributed across multiple servers. A classification server 106 may be connected to the network 110, serving as the central intelligence for dynamic quantization decisions. The system 100 may include a database 108, which may store relevant data for the quantization process.

In operation, a user may input a query into the user device 102, which may then be transmitted through the network 110 to the LLM 104. The LLM 104 may process the query, passing the input and output of each layer to the classification server 106. The classification server 106 may analyze the original query data and the output data from the current layer of the LLM to predict the optimal quantization level for the subsequent layer of the LLM 104.

For example, if a user inputs a complex tax-related query, the classification server 106 may determine that the initial layers of the LLM 104 require full precision to accurately process the intricate details of tax law. However, for subsequent layers dealing with more general language processing, the classification server 106 may predict that a lower precision (e.g., int8 or int4) is sufficient, thereby reducing computational requirements without significantly impacting accuracy.

The system 100 may employ a hierarchical architecture to manage multiple user devices efficiently. Local aggregators may oversee groups of edge devices, such as multiple user devices 102 in a specific geographic region or within a particular organization. These local aggregators may communicate with the classification server 106, potentially reducing network traffic and enabling more efficient model updates.

The database 108 may store various types of data beneficial for the dynamic quantization process. This may include historical query data, model parameters, and performance metrics for different quantization levels. The classification server 106 may access this data to refine its quantization predictions over time, potentially improving the overall efficiency of the system 100.

In a specific use case, the system 100 may be employed by a multinational tax consultancy firm. The firm's employees (using various user devices 102) may input complex tax queries from different countries. The LLM 104 may process these queries, with the classification server 106 dynamically adjusting the quantization levels of different layers based on the complexity and nature of each query. This dynamic approach may allow the firm to provide rapid, accurate responses to diverse tax inquiries while optimizing its computational resources across different global offices.

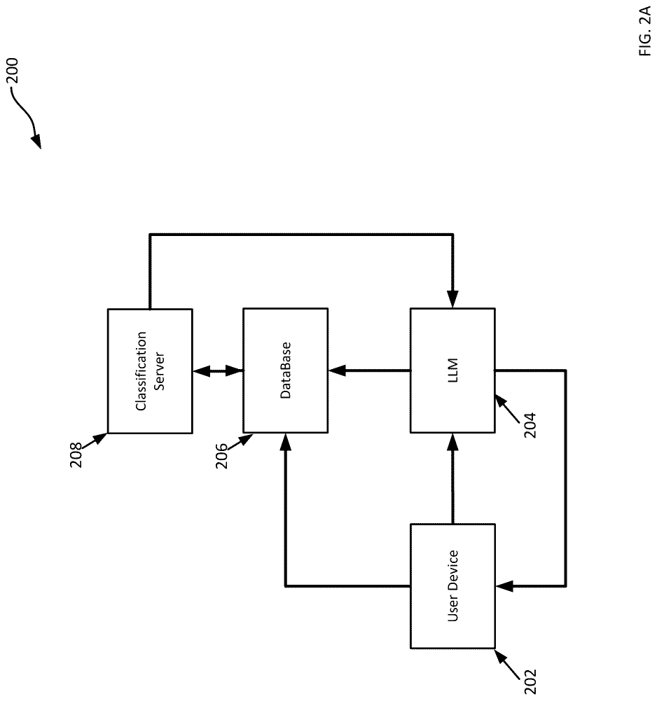

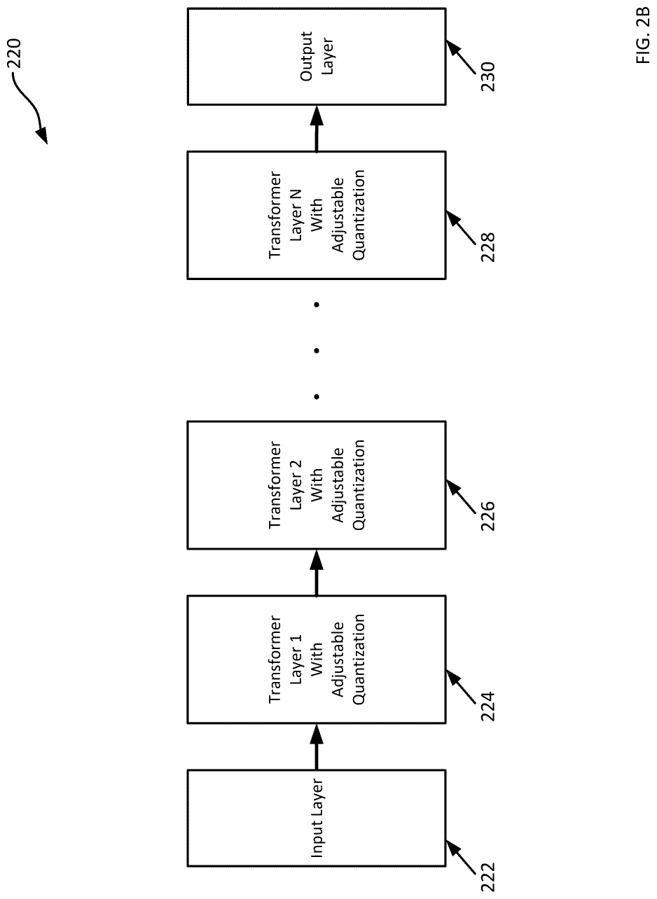

FIG. 2A illustrates a block diagram of a system 200 for dynamic layer quantization of an LLM. The system 200 may comprise a user device 202, an LLM 204, a database 206, and a classification server 208.

A user device 202 may be connected to the LLM 204 and the database 206. The user device 202 may send queries or inputs to the LLM 204 for processing and may also send data to the database 206 for storage. In some cases, the user device 202 may be a smartphone, tablet, laptop, or desktop computer.

The LLM 204 may be connected to the user device 202, the database 206, and the classification server 208. The LLM 204 may process queries from the user device 202, interact with the database 206 for data retrieval or storage, and may communicate with the classification server 208 for layer quantization decisions. In some cases, the LLM 204 may be a neural network-based language model capable of understanding and generating human-like text.

The database 206 may be connected to the user device 202, the LLM 204, and the classification server 208. The database 206 may store data that can be accessed by the other components of the system 200, including user queries, model parameters, and quantization-related information. In some cases, the database 206 may be a distributed database system capable of handling large volumes of data.

The classification server 208 may be connected to the LLM 204 and the database 206. The classification server 208 may analyze the input and hidden representations from the LLM 204 to determine the appropriate quantization levels for each layer of the LLM 204. The classification server 208 may access the database 206 to retrieve or store information related to the quantization process.

The classification server 208 may employ various models and techniques to perform the classification for dynamic layer quantization. In some implementations, the server may utilize another language model or LLM specifically trained for quantization prediction tasks. Decision trees or random forests may be used to make branching decisions based on input features and layer outputs. Neural networks, such as multi-layer perceptrons or convolutional neural networks, may be employed to learn complex patterns in the data for quantization level prediction. Support vector machines (SVMs) may be utilized for their ability to handle high-dimensional data and perform well in binary or multi-class classification tasks. Gradient boosting algorithms, like eXtreme Gradient Boost (XGBoost) or Light Gradient Boost Machine (LightGBM), may be implemented for their efficiency and performance in handling large datasets. In some cases, ensemble methods combining multiple classifiers may be used to improve prediction accuracy. The server may also incorporate reinforcement learning techniques to adaptively improve quantization decisions over time based on performance feedback. Bayesian models may be employed to handle uncertainty in quantization level predictions, potentially providing probabilistic outputs for different quantization levels.

In operation, the system 200 may function as follows: The user device 202 may send a query to the LLM 204. As the LLM 204 processes this query, the LLM 204 may interact with the classification server 208 to dynamically adjust the quantization levels of the LLM 204 layers. The classification server 208 may make adjustment decisions based on the analysis of input and hidden representations, potentially using data stored in the database 206.

For example, consider a user asking a complex question about quantum physics using the user device 202. The query may be sent to the LLM 204 for processing. As the LLM 204 begins to process the query through its layers, the classification server 208 may analyze the input and the output of each layer. Based on this analysis, the classification server 208 may determine that the complexity of the query requires higher precision in layers of the LLM 204.

The classification server 208 may predict and select higher quantization levels (e.g., full precision or FP16) for these complex layers, while maintaining lower quantization levels (e.g., int8 or int4) for simpler layers. The LLM 204 may then process the query using these dynamically assigned quantization levels, potentially achieving a balance between computational efficiency and accuracy. FP16 refers to 16-bit floating point precision, which uses 16 bits to represent a number. Int8 and int4 refer to 8-bit and 4-bit integer precision respectively, which use 8 bits and 4 bits to represent integers. These are of course examples, and it is noted that other levels of precision are possible. Changing a layer's quantization level generally includes modifying how numerical values are represented and stored within that layer. This can affect the range and precision of values the layer can represent, as well as its computational requirements. A layer's architecture may include weights, biases, and activation functions. The quantization level determines the bit-width used to store these parameters and perform computations. Higher precision (e.g. full precision or FP16) allows for more accurate representation of values but requires more memory and computational resources. Lower precision (e.g. int8 or int4) reduces memory and computational needs but may impact accuracy. The relationship between a layer's architecture and its quantization level may involve balancing accuracy, memory usage, and computational efficiency based on the layer's role and complexity within the overall model. The LLM 204 may then process the query using these dynamically assigned quantization levels, potentially achieving a balance between computational efficiency and accuracy.

The LLM 204 may output the response to the quantum physics query back to the user device 202. Throughout this process, the database 206 may be used to store and retrieve relevant data, such as the original query, intermediate processing results, and the final response.

This dynamic quantization process may optimize the performance and efficiency of the LLM 204 during inference, potentially allowing for more efficient use of computational resources while maintaining model accuracy for complex queries.

FIG. 2B illustrates an LLM layers 220 with dynamic layer quantization. The LLM layers 220 includes an input layer 222, multiple transformer layers (224, 226, 228), and an output layer 230 arranged in a sequential configuration.

An LLM layer is a building block of the overall LLM architecture. These layers may be stacked sequentially to form the complete LLM structure, with each layer potentially performing specific transformations on the input data as it flows through the model. In some cases, an LLM layer may include various sub-components such as self-attention mechanisms, feed-forward neural networks, and normalization operations, which work together to process and transform the input representations. Each layer may contribute to the overall function of the LLM by performing specialized operations on the data, gradually transforming raw input into meaningful representations and ultimately generating the final output. The collective interaction and information flow between these layers may enable the LLM to understand and generate complex language patterns. In some implementations, the number and configuration of these layers may influence the model's capacity, performance, and computational requirements.

In general, input layer 222 receives input data and forwards it to the first transformer layer 224. The processed data flows through subsequent transformer layers until reaching the Nth transformer layer 228, which represents the final transformer layer. The output layer 230 then produces the final output of the LLM layers 220. Each transformer layer (224, 226, 228) in the LLM layers 220 may contain adjustable quantization parameters that can be dynamically modified based on computational requirements and performance needs. These quantization parameters may control the precision of computations within each layer, potentially allowing for a balance between accuracy and efficiency. The system may adjust the quantization levels of each transformer layer independently, potentially optimizing the overall performance of the LLM. For example, the first transformer layer 224 may operate at a higher precision to capture intricate input features, while subsequent layers may use lower precision as the data becomes more abstract.

The adjustable quantization in transformer layers may be controlled by the classification server 208 based on various factors such as input complexity, device capabilities, and performance requirements. The classification server 208 may analyze the input and output of each layer to predict the optimal quantization level for the subsequent layer. This dynamic approach may allow the system to adapt the LLM's computational precision in real-time, potentially maximizing efficiency while maintaining accuracy for diverse types of queries and computational environments.

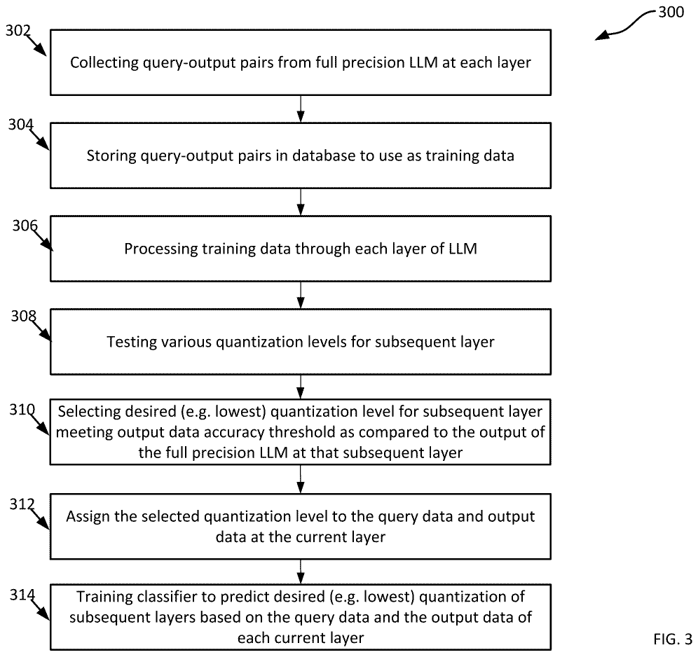

FIG. 3 illustrates a method 300 for training a classifier to predict quantization levels for layers of an LLM. The method 300 may begin at 302, where system 100 may collect query-output pairs from a full precision LLM at each layer. In this step, the system 100 may process a diverse set of user queries through the full precision LLM 104, recording the input and output at each layer. This data collection process may be beneficial for establishing a baseline performance against which quantized versions can be compared.

System 100 may store the collected query-output pairs may be stored in the database 108 at 304, creating a comprehensive training dataset. This dataset may serve as the foundation for training the classifier, providing a rich source of examples that span various query types and complexities. By storing this data, the system 100 may enable repeated training iterations and performance comparisons without the need to regenerate the full precision outputs each time.

At 306, system 100 may process the training data through each layer of the LLM. This processing may be performed on the classification server 106, which may analyze how the input data transforms as it passes through each layer of the full precision LLM 104. By tracking these transformations, the classification server 106 may gain insights into the importance of precision at different stages of the model's processing.

The processing of training data may involve complex matrix operations and may require significant computational resources. However, this step may be beneficial for understanding the behavior of the full precision model and identifying opportunities for quantization without significant loss of accuracy.

At 308, system 100 may test various quantization levels for the subsequent layer of the LLM. The classification server 106 may apply different quantization levels to the weights and activations of the subsequent layer, including full precision, FP16, int8, and int4. Each quantization level may be tested with the same input data, allowing for a direct comparison of each respective quantization level's impact on the layer's output.

The testing of quantization levels may involve multiple forward passes through the layer, each with a different precision level. This process may be computationally intensive but may provide valuable data on the trade-offs between precision and performance for each layer of the LLM 104.

At 310, system 100 may select the desired quantization level for the subsequent layer that meets an output data accuracy threshold when compared to the output of the full precision LLM at that subsequent layer. This selection process may involve comparing the outputs of the quantized layers to the full precision output using a metric such as cosine similarity. The classification server 106 may choose the lowest precision level that maintains a similarity above a predetermined threshold.

The selection of the appropriate quantization level may be a beneficial step in balancing model performance and computational efficiency. By choosing the lowest acceptable precision, the system 100 may significantly reduce memory requirements and computational load without compromising the model's accuracy beyond an acceptable level.

At 312, system 100 may assign the selected quantization level to the query data and output data at the current layer. This assignment may create a labeled dataset that associates specific input patterns and layer outputs with the optimal quantization level for the subsequent layer. This labeled data may serve as the training set for the classifier.

The assignment process may involve updating the database 108 with the selected quantization levels, creating a comprehensive record of optimal precision choices for various input patterns and layer states. This data may be beneficial for training a classifier that can make accurate predictions during inference.

At 314, system 100 may train the classifier to predict the desired quantization of subsequent layers based on the query data and the output data of each current layer. This training process may involve machine learning techniques such as supervised learning, where the classifier learns to associate input features (query data and current layer output) with the optimal quantization level for the next layer.

The training of the classifier may be an iterative process, potentially involving techniques such as cross-validation to ensure the classifier generalizes well to unseen data. The resulting trained classifier may be capable of making real-time decisions about layer quantization during inference, potentially enabling dynamic adaptation to different query complexities and computational resources.

As a use case example, consider a tax preparation software application that uses an LLM for processing tax-related queries and generating responses. The system 100 may train the classifier using a dataset of common tax-related questions, ranging from simple inquiries about filing deadlines to complex questions about tax deductions and credits. During the training process, the classification server 106 may determine that for basic tax questions, the initial layers of the LLM 104 can be quantized to int8 without significant loss of accuracy. However, for complex tax scenarios, the classifier may learn that the initial layers require full precision or FP16 to maintain accuracy, while later layers can be quantized more aggressively.

In this use case, at 302, the system may collect query-output pairs from a full precision LLM at each layer, using a diverse set of tax-related queries. At 304, the system may store these query-output pairs in the database 108, creating a comprehensive training dataset for tax preparation scenarios. At 306, the classification server 106 may process this training data through each layer of the LLM, analyzing how tax-related queries transform as they pass through the model.

In this use case, at 308, system processing may involve testing various quantization levels for subsequent layers, applying different precision levels to weights and activations for tax-specific processing. At 310, the classification server 106 may select the quantization level for each layer that maintains accuracy above a predetermined threshold for tax-related outputs. At 312, the system may assign these selected quantization levels to the corresponding tax query data and layer outputs.

In this use case, at 314, the classifier may be trained to predict the optimal quantization of subsequent layers based on the tax query data and the output of each current layer. This trained classifier may then be used to dynamically adjust the quantization levels of the LLM 104 as users interact with the tax preparation software, potentially optimizing performance based on the complexity of each tax-related query or calculation.

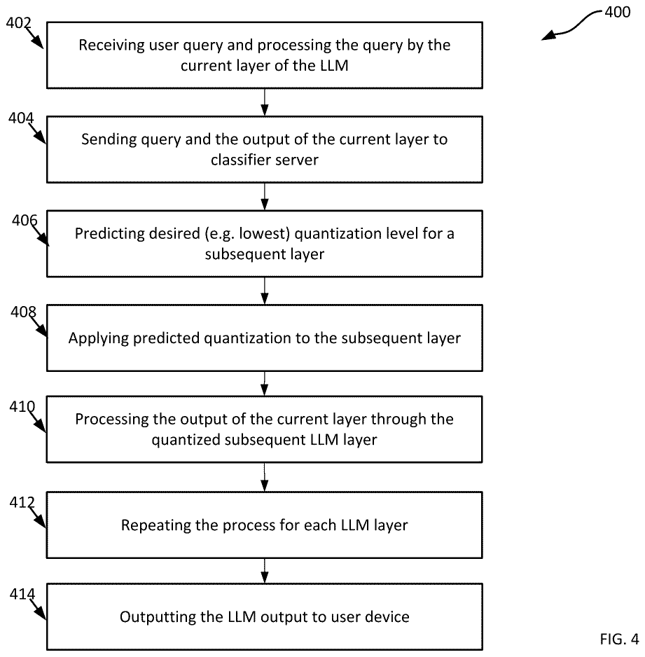

FIG. 4 illustrates a flowchart of a method 400 for dynamic layer quantization in an LLM. The method 400 may provide a structured approach to dynamically adjusting the precision of LLM layers during inference, potentially optimizing the balance between computational efficiency and model accuracy.

The method 400 may begin at 402, where system 200 may receive a user query that may be processed by the current layer of the LLM. The user device 202 may send a query to the LLM 204. The LLM 204 may then process this query through its current layer. This processing may involve various operations such as tokenization, embedding, and initial feature extraction. The complexity of the query and the nature of the current layer may influence how the data is processed and represented.

For example, if the user query is related to tax preparation, such as “What deductions can I claim for my home office?”, the current layer of the LLM 204 may process this input by tokenizing the words, converting them into numerical representations, and performing initial semantic analysis. The output of this layer may be a high-dimensional vector representing the processed tax-related query.

At 404, a classifier server may receive the query and the output of the current layer. The LLM 204 may transmit both the original query data and the processed output from the current layer to the classification server 208. This may benefit the dynamic quantization process as it provides the classification server 208 with information that may enable informed decisions about the quantization levels for subsequent layers.

The classification server 208 may receive this data and prepare it for analysis. This preparation may involve normalizing the data, extracting relevant features, or applying any preprocessing techniques that may enhance the classifier's ability to predict appropriate quantization levels.

At 406, system 200 may predict the desired quantization level for a subsequent layer of the LLM. The classification server 208 may use a trained classifier to analyze the query data and the output from the current layer of the LLM 204. This classifier may be a machine learning model, such as a neural network or decision tree, that has been trained on historical data to predict optimal quantization levels.

The prediction process may involve evaluating various factors such as the complexity of the query, the characteristics of the current layer's output, and potentially even contextual information about the user or the device. For instance, if the query is determined to be complex or if the current layer's output shows high variability, the classifier may predict that a higher precision (e.g., full precision or FP16) is beneficial for the subsequent layer.

At 408, the predicted quantization may be applied to the subsequent layer of the LLM. Once the classification server 208 has predicted the desired quantization level, this information may be sent back to the LLM 204. The LLM 204 may then dynamically adjust the precision of its subsequent layer according to this prediction.

This dynamic adjustment may involve loading different versions of the layer weights (e.g., full precision, FP16, int8, or int4) or applying quantization operations on-the-fly. The ability to dynamically adjust quantization levels may allow the LLM 204 to adapt to the specific requirements of each query and optimize resource usage.

At 410, system 200 may process the output of the current layer through the quantized subsequent LLM layer. After the quantization has been applied, the LLM 204 may process the output from the current layer through the newly quantized subsequent layer. This may allow for the evaluation of the quantization's impact on the model's performance.

The processing at 410 may involve various operations depending on the nature of the layer, such as self-attention mechanisms in transformer-based models or convolutions in convolutional neural network (CNN)-based models. The quantized layer may perform these operations with reduced precision, potentially leading to computational savings without significant loss in accuracy.

At 412, the process may be repeated for each LLM layer. The method 400 may iterate through 404 to 410 for each layer of the LLM 204. This iterative process may ensure that each layer of the model is dynamically quantized based on the specific characteristics of the input and the output of the preceding layer.

This repetition may allow for fine-grained control over the precision of each layer, potentially optimizing the overall performance of the LLM 204. For example, early layers dealing with low-level features may be quantized more aggressively, while later layers handling more abstract representations may require higher precision.

At 414, system 200 may send the LLM output to the user device. Once all layers have been processed with their dynamically determined quantization levels, the LLM 204 may produce its final output. This output is then sent back to the user device 202, completing the process of dynamic layer quantization and providing the user with the results of their query.

The final output may benefit from the optimized processing enabled by dynamic quantization. By adjusting precision levels throughout the model, the method 400 may achieve a balance between computational efficiency and output quality, potentially providing faster responses without significant degradation in accuracy.

The methods may use various algorithms to achieve their goal. For example, at 402, the LLM 204 may employ tokenization techniques such as Byte-Pair Encoding or WordPiece to convert the input query into a sequence of tokens. These tokens may then be embedded into a high-dimensional vector space using techniques like word2vec or Global Vectors for Word Representation (GloVe). The current layer may apply self-attention mechanisms or convolutional operations to extract initial features from the embedded input. At 404, the query data and layer output may be serialized into a standardized format, such as Protocol Buffers or javascript object notation (JSON), before being transmitted to the classification server 208 via secure network protocols like hypertext transfer protocol secure (HTTPS) or remove procedure call (gRPC). The classification server 208 may use data normalization techniques such as z-score normalization or min-max scaling to prepare the received data for analysis. At 406 and 408, system processing may involve the use of ensemble learning techniques, combining predictions from multiple models such as random forests, gradient boosting machines, and neural networks to determine the optimal quantization level. The classifier may utilize techniques like one-hot encoding for categorical features and feature scaling for numerical inputs. The predicted quantization may be applied using dynamic computational graphs, allowing for on-the-fly adjustment of layer precision. At 410 and 412, system processing may involve techniques like mixed-precision training, where different parts of the model operate at different precisions. The iterative process may use adaptive learning rates and layer-wise adaptive rate scaling (LARS) to optimize the training process across different quantization levels. At 414, the final output may be post-processed using techniques like beam search or nucleus sampling to generate coherent and relevant responses.

In the tax preparation software use case, processing at 402 may involve processing the user's query “What deductions can I claim for my home office?” by tokenizing it into individual words and phrases, and then converting these into numerical representations that capture the semantic meaning of tax-related terms. At 404, the system may then package this processed query along with the output of the initial layer, which may include features related to the identification of key tax concepts like “deductions” and “home office”, and send this data to the classification server 208 for analysis.

In this use case, at 406 and 408, the classifier may predict that the subsequent layers dealing with specific tax regulations require higher precision (e.g., FP16) to accurately process the nuanced information about home office deductions. The LLM 204 may then adjust its layer quantization accordingly. At 410 and 412, the system may process the query through layers that analyze applicable tax laws, calculate potential deduction amounts, and generate explanations, with each layer operating at its dynamically determined precision level. At 414, the LLM 204 may generate a detailed response explaining the eligible deductions for a home office, including specific criteria and calculation methods, and send this information back to the user's smartphone in a format optimized for display on a mobile device.

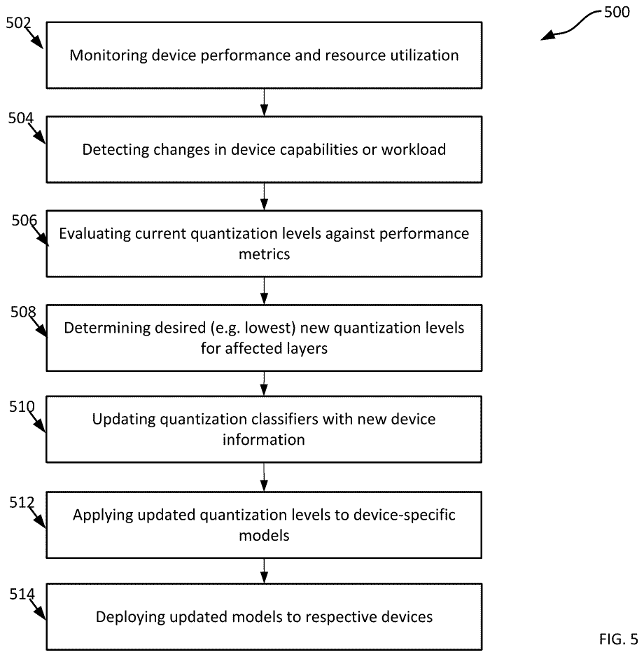

FIG. 5 illustrates a method 500 for dynamic quantization adjustment. The method 500 may begin with monitoring device performance and resource utilization at 502. The system 200 may continuously track various metrics related to the performance of the user device 202 and the utilization of its computational resources. These metrics may include central processing unit (CPU) usage, memory consumption, battery level, network bandwidth, and response times for different operations. The monitoring process may involve collecting real-time data from the user device 202 and storing it in the database 206 for analysis.

The performance monitoring may be beneficial for understanding the current state of the user device 202 and its ability to handle different quantization levels. For example, if the user device 202 is a smartphone running on low battery power, the system 200 may adjust its quantization strategy to conserve energy while maintaining acceptable performance. The classification server 208 may analyze the collected performance data to identify patterns and trends that could inform quantization decisions.

At 504, system 200 may detect changes in device capabilities or workload. This detecting may build upon the data collected at 502, focusing on identifying significant shifts in the user device 202's operational parameters. The classification server 208 may employ various algorithms to detect these changes, such as statistical analysis, machine learning models, or rule-based systems. Changes that may be detected could include sudden spikes in CPU usage, drops in available memory, or transitions between different power states.

The detection of changes may be a dynamic process that adapts to the specific characteristics of each user device 202. For instance, what constitutes a significant change in workload for a high-end smartphone may be different from that of a low-end tablet. The classification server 208 may maintain device-specific thresholds and baselines in the database 206, allowing for personalized change detection across a diverse range of devices.

At 506, system 200 may evaluate current quantization levels against performance metrics. The classification server 208 may analyze how well the current quantization strategy is performing given the latest device performance data. This evaluation may involve comparing the actual performance metrics of the quantized LLM 204 against predefined targets or historical data stored in the database 206. The classification server 208 may calculate various performance indicators, such as inference time, accuracy, and resource utilization for each layer of the LLM 204.

The evaluation process may be multi-faceted, considering not only the overall performance of the LLM 204 but also the performance of individual layers under different quantization levels. For example, the classification server 208 may determine that while the current quantization strategy is generally effective, layers are underperforming due to overly aggressive quantization. This detailed analysis may provide valuable insights for fine-tuning the quantization approach.

At 508, system 200 may determine new quantization levels for affected layers. Based on the evaluation results from 506, the classification server 208 may decide which layers of the LLM 204 require adjustments to their quantization levels. This determination may involve a complex decision-making process that balances multiple factors, including the current device performance, the importance of each layer to overall model accuracy, and the potential resource savings from quantization.

The process of determining new quantization levels may leverage machine learning techniques to predict the optimal precision for each layer. The classification server 208 may use historical data stored in the database 206 to train models that can suggest appropriate quantization levels based on current device conditions and layer characteristics. For instance, if the user device 202 is experiencing high CPU load, the classification server 208 may recommend reducing the precision of computationally intensive layers while maintaining higher precision for important layers that impact model accuracy.

At 510, system 200 may update quantization classifiers with new device information. The classification server 208 may refine its quantization prediction models based on the latest device performance data and the outcomes of recent quantization adjustments. This update process may ensure that the classifiers remain accurate and relevant as device capabilities and usage patterns evolve over time.

The classifier update process may involve techniques such as online learning or periodic retraining. The classification server 208 may incorporate new data points into its existing models, adjusting the weights and parameters to reflect recent device behavior. This continuous learning approach may allow the system 200 to adapt to long-term trends in device performance and user behavior, potentially improving the accuracy of quantization predictions over time.

At 512, system 200 may apply the updated quantization levels to device-specific models. This may involve reconfiguring the LLM 204 on the user device 202 to use the newly determined quantization levels for each layer. The classification server 208 may generate device-specific quantization instructions, which may be transmitted to the user device 202 over the network 110. These instructions may specify the precision to be used for each layer of the LLM 204, potentially allowing for fine-grained control over the model's resource usage and performance characteristics.

The application of updated quantization levels may be performed dynamically, without requiring a full model reload or significant interruption to the user's experience. For example, the system 200 may implement a hot-swapping mechanism that allows individual layers of the LLM 204 to be requantized on-the-fly as the model processes user queries. This dynamic approach may enable rapid adaptation to changing device conditions and workloads.

At 514, system 200 may deploy the updated models to respective devices. This may involve transmitting the requantized model or quantization parameters to the user device 202. The deployment process may be optimized to minimize data transfer and downtime, potentially using techniques such as delta updates or progressive loading. The classification server 208 may coordinate the deployment to ensure that the updated model is seamlessly integrated into the user device 202's existing workflows.

The deployment may also include verification and rollback mechanisms to ensure the reliability of the updated model. For instance, the system 200 may perform a quick validation of the requantized model on the user device 202 before fully committing to the changes. If any issues are detected, the system 200 may automatically revert to the previous quantization configuration, ensuring uninterrupted service for the user.

System 200 may use various algorithms to achieve its goal. For example, at 502, the system may employ various monitoring techniques such as performance counters, system calls, and hardware sensors to collect real-time data on device performance and resource utilization. This data may be processed using time series analysis algorithms to identify trends and anomalies. At 504, the system may utilize change point detection algorithms, such as CUSUM or Bayesian online changepoint detection, to identify significant shifts in device capabilities or workload. These algorithms may be combined with machine learning models, such as random forests or support vector machines, to classify the detected changes and determine their impact on the quantization strategy. At 506, system processing may involve the use of statistical hypothesis testing, such as t-tests or ANOVA, to compare the performance metrics of the current quantization levels against predefined benchmarks. The system may also employ techniques like cross-validation and bootstrapping to ensure the reliability of these comparisons. At 508, the system may use reinforcement learning algorithms, such as Q-learning or policy gradients, to determine optimal quantization levels for affected layers. These algorithms may be combined with neural architecture search techniques to explore different quantization configurations efficiently. At 510, system processing may involve the use of online learning algorithms, such as stochastic gradient descent or adaptive moment estimation (Adam), to update the quantization classifiers. The system may also employ techniques like transfer learning or meta-learning to leverage knowledge from other devices or domains. At 512 and 514, the system may utilize dynamic linking and loading techniques to apply updated quantization levels without interrupting model execution. The system may also employ containerization or virtualization technologies to manage different versions of the quantized models and facilitate seamless deployment.

In the context of the tax preparation software use case, at 502, system processing may involve monitoring the user's smartphone performance while running the tax software, tracking metrics such as CPU usage during tax calculation operations and memory consumption when loading tax forms. At 504, the system may detect changes such as the user switching from Wi-Fi to cellular data while researching tax deductions, or the device entering a low-power mode during an extended tax filing session. At 506, the system may evaluate how well the current quantization levels are performing for different tax-related tasks, such as calculating deductions or generating tax summaries, comparing these performance metrics against predefined targets for response time and accuracy.

In this use case, at 508, the system may determine new quantization levels for specific layers of the tax preparation model, such as increasing precision for layers dealing with complex tax calculations while reducing precision for layers handling simpler tasks like data input validation. At 510, the system may update the quantization classifiers based on the performance of the tax software across different user devices and tax scenarios, improving its ability to predict optimal quantization levels for future tax-related queries. At 512, the system may apply the updated quantization levels to the tax preparation model on the user's smartphone, potentially improving performance for specific tax operations without requiring a full app update. At 514, the system may deploy the updated tax preparation model to the user's device, ensuring that the new quantization levels are applied smoothly without interrupting any ongoing tax filing processes, and validating that the updated model maintains accuracy in tax calculations and advice generation.

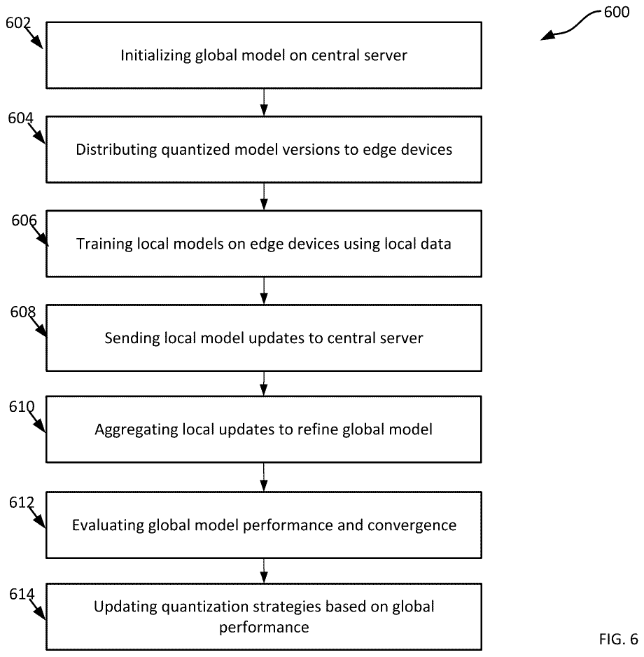

FIG. 6 illustrates a flowchart of a method 600 for implementing a federated learning process with dynamic quantization. The method 600 may combine the principles of federated learning with dynamic layer quantization, potentially enabling efficient distributed model training while optimizing model precision across different devices.

At 602, system 200 may initialize a global classifier model on a central server. The classification server 208 may create an initial version of the global model, which may serve as the starting point for the federated learning process. This global model may incorporate the dynamic quantization capabilities, with initial quantization levels set based on predetermined criteria or historical data.

The initialization process may involve setting up the model architecture, initializing weights, and defining the quantization strategies for different layers. The classification server 208 may also establish the protocols for communication with edge devices and define the metrics for evaluating model performance and convergence.

At 604, system 200 may include distributing quantized model versions to edge devices. The classification server 208 may send customized versions of the global model to various user devices 202. These versions may be quantized based on the specific capabilities of each user device 202, as determined by the classification server 208 through device profiling or historical performance data.

The distribution process may involve compressing the model for efficient transmission over the network 110 and may include mechanisms for secure model transfer to protect the integrity and confidentiality of the model. The user devices 202 may receive these quantized models and prepare them for local training.

At 606, system 200 may train the quantized model versions on the edge devices using local data. Each user device 202 may use its local dataset to fine-tune the received quantized model. This local training process may allow the model to adapt to user-specific patterns and data distributions without sharing raw data with the central server.

The training on user devices 202 may involve techniques such as mini-batch gradient descent, with the quantization levels dynamically adjusted during the process. The LLM 204 on each user device 202 may work in conjunction with a local version of the classification server 208 to optimize the quantization levels for each layer based on the specific characteristics of the local data and the device's computational capabilities.

At 608, system 200 may send local model updates from the edge devices back to the central server. After a predetermined number of training iterations or upon reaching performance thresholds, each user device 202 may compute the changes in model parameters resulting from the local training. These updates, rather than the raw data or the entire model, may be sent back to the classification server 208.

The update process may involve techniques to ensure privacy and security, such as differential privacy or secure aggregation protocols. The updates may also include metadata about the performance of different quantization levels during local training, which may be used by the classification server 208 to refine the global quantization strategy.

At 610, system 200 may aggregate the local updates to refine the global model. The classification server 208 may combine the updates received from multiple user devices 202 to improve the global model. This aggregation process may use techniques such as federated averaging, where the updates are weighted based on factors like the amount of local data or the reliability of the user device 202.

The aggregation may involve reconciling potentially conflicting updates and ensuring the coherence of the global model. The classification server 208 may apply adaptive learning rates and regularization techniques to stabilize the learning process and prevent overfitting to any particular user's data.

At 612, system 200 may evaluate global model performance and convergence. After aggregating the updates, the classification server 208 may assess the performance of the refined global model using predefined metrics. This evaluation may involve testing the model on a held-out validation dataset or using cross-device validation techniques.

The convergence assessment may consider factors such as the rate of improvement in model performance, the consistency of updates across devices, and the stability of the quantization levels. The classification server 208 may use this information to determine whether further rounds of federated learning are necessary or if the model has reached a satisfactory level of performance.

At 614, system 200 may update quantization strategies based on the global performance. Based on the evaluation results, the classification server 208 may refine the quantization strategies for different layers of the model. This may involve adjusting the quantization levels, modifying the criteria for dynamic quantization, or updating the classifiers used to predict optimal quantization levels.

The update process may consider the performance trade-offs observed across different devices and quantization levels. The classification server 208 may use techniques such as Bayesian optimization or reinforcement learning to continuously improve the quantization strategies, potentially leading to more efficient model deployment in subsequent rounds of federated learning.

System 200 may use various algorithms to achieve its goal. For example, at 602, the global classifier model initialization may involve techniques such as transfer learning from pre-trained language models or knowledge distillation to create a compact yet effective starting point. The model architecture may be designed using neural architecture search algorithms to optimize for both accuracy and efficiency across diverse devices. At 604, the system may employ model compression techniques like pruning and quantization-aware training to create device-specific versions. The distribution process may utilize secure multi-party computation protocols to ensure privacy during model transfer. At 606, the system may implement federated averaging with adaptive learning rates, where each device adjusts its local learning rate based on its computational capabilities and data characteristics. The local training may also incorporate techniques like mixup or data augmentation to enhance generalization from limited local datasets.

At 608, the system may use secure aggregation protocols that allow devices to share model updates without revealing individual contributions. The update compression may employ techniques like gradient quantization or sketching to reduce communication overhead. At 610, the system may utilize adaptive aggregation methods that dynamically adjust the influence of each device's update based on factors like update quality and device reliability. The aggregation process may incorporate techniques like Federated Dropout to handle heterogeneous model architectures across devices. At 612, the system may employ multi-task evaluation metrics to assess performance across various language tasks and device types. The convergence analysis may use techniques like federated validation to estimate global model performance without centralizing data. At 614, the system may implement meta-learning approaches to dynamically adjust quantization strategies based on observed performance patterns across devices and tasks. The update process may incorporate continual learning techniques to prevent catastrophic forgetting of previously learned quantization strategies.

In the context of the tax preparation software use case, at 602, system processing may involve initializing a global tax calculation model that incorporates basic tax rules and regulations applicable across various jurisdictions. The model may be structured to handle different types of tax calculations, from simple income tax to complex business deductions. At 604, the system may distribute customized versions of this tax model to user devices, with quantization levels tailored to each device's processing capabilities. For instance, high-end smartphones may receive models with higher precision for complex tax calculations, while budget devices may get more aggressively quantized versions optimized for basic tax filing tasks.

At 606, system processing may involve each user's device fine-tuning the tax model based on their local tax data and filing history. This process may allow the model to adapt to specific tax situations without sharing sensitive financial information. At 608, the devices may send back updates on how well tax calculation methods performed, without transmitting actual tax data. At 610, the system may aggregate these insights to improve the global tax model's accuracy across various tax scenarios. At 612, the system may evaluate the model's performance on a range of tax calculation tasks, from simple deductions to complex international tax situations. At 614, the system may update the quantization strategies for different parts of the tax model. For example, the system may increase precision for layers handling new tax laws or complex deductions, while maintaining lower precision for stable, well-established tax calculation procedures.

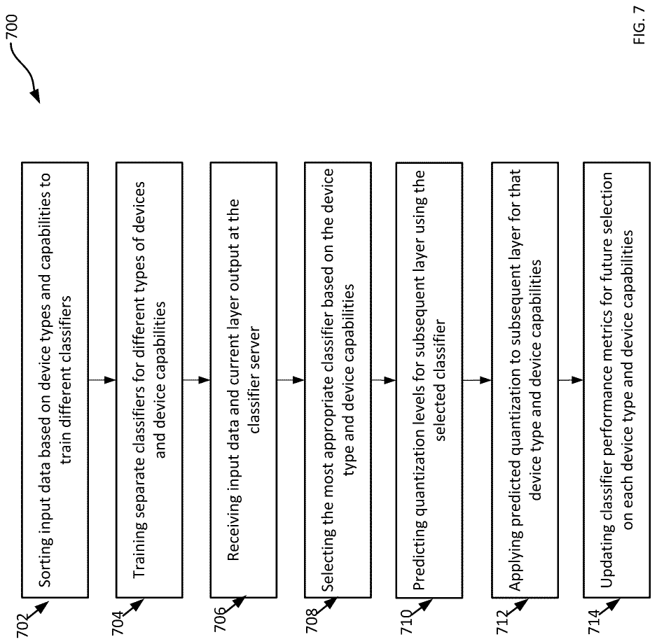

FIG. 7 illustrates a flowchart of a method 700 for multi-classifier quantization processing. The method 700 may begin at 702, where system 200 may sort input data based on device types and capabilities to train different classifiers. This sorting may involve categorizing the input data according to various device characteristics such as processing power, memory capacity, and available hardware accelerators. The classification server 208 may analyze metadata associated with each input sample, such as the device model, operating system version, and hardware specifications, to determine the appropriate category for sorting.

The sorting process may employ machine learning techniques, such as clustering algorithms, to group similar devices based on their capabilities. For example, high-end smartphones with dedicated AI processors may be grouped together, while budget devices with limited resources may form another cluster. This categorization may enable the system 200 to develop specialized quantization strategies for each device category, potentially optimizing performance across a diverse range of hardware.

At 704, system 200 may train separate classifiers for different types of devices and device capabilities. The classification server 208 may use the sorted input data to train multiple classifiers, each specialized for a specific device category. These classifiers may be designed to predict optimal quantization levels for different layers of the LLM 204 based on the characteristics of each device type.

The training process may involve techniques such as transfer learning, where a base model is fine-tuned for each device category. For instance, a classifier trained on high-end devices may be adapted for mid-range devices by adjusting its parameters to account for reduced computational resources. The classification server 208 may employ techniques like elastic weight consolidation to prevent catastrophic forgetting when adapting classifiers across device categories. Additionally, progressive neural networks may be used to allow classifiers to leverage knowledge from related device categories while maintaining specialization for their target devices.

At 706, system 200 may receive input data and current layer output at the classifier server. During inference, when a user query is processed by the LLM 204 on the user device 202, the input data and the output of the current layer may be sent to the classification server 208. This data may include the original query, the processed output from the current layer of the LLM 204, and metadata about the user device 202.

The classification server 208 may preprocess this received data, potentially normalizing the inputs and extracting relevant features that are indicative of the complexity of the current processing task. For example, the server may analyze the semantic complexity of the user query, the dimensionality of the layer output, and the current resource utilization of the user device 202. This preprocessed data may serve as the input for the appropriate classifier in the subsequent step.

At 708, system 200 may select the appropriate classifier based on the device type and device capabilities. The classification server 208 may analyze the metadata received from the user device 202 to determine which specialized classifier is suitable for predicting the quantization levels. This selection process may involve comparing the device characteristics to the profiles of the trained classifiers and choosing the one that is compatible with the current device.

The classifier selection may be a dynamic process that adapts to changes in device capabilities or operating conditions. For example, the classification server 208 may receive periodic status updates from the user device 202, which may include information about the device's current power state. Additionally, the user device 202 may be configured to send an immediate notification to the classification server 208 when it enters low-power mode, allowing the server to promptly adjust its classifier selection and quantization strategies. Therefore, if a device enters a low-power mode, the classification server 208 may switch to a classifier trained specifically for energy-constrained scenarios. This adaptive approach may allow the system 200 to maintain optimal performance across varying device states and usage patterns.

At 710, system 200 may predict quantization levels for the subsequent layer using the selected classifier. The chosen classifier may analyze the preprocessed input data and current layer output to determine the optimal quantization level for the next layer of the LLM 204. This prediction may take into account factors such as the complexity of the current processing task, the available resources on the user device 202, and the historical performance of different quantization levels on similar devices.

The prediction process may involve sophisticated machine learning techniques, such as ensemble methods or deep neural networks, to capture complex relationships between input features and optimal quantization levels. The classifier may output a probability distribution over possible quantization levels, allowing the system 200 to make nuanced decisions that balance performance and resource utilization. For example, if the classifier predicts a high probability for both 8-bit and 16-bit quantization, the system 200 may choose the more aggressive 8-bit quantization to save resources, but with the option to fall back to 16-bit if beneficial.

At 712, system 200 may apply the predicted quantization to the subsequent layer for that device type and device capabilities. The classification server 208 may send the predicted quantization level back to the user device 202, where the LLM 204 may dynamically adjust the precision of the subsequent layer accordingly. This adjustment may involve loading pre-quantized weights, applying quantization operations on-the-fly, or reconfiguring the layer's computational graph to operate at the specified precision.

The application of quantization may be optimized for the specific hardware of the user device 202. For instance, on devices with dedicated AI accelerators, the quantization may be applied in a way that leverages hardware-specific optimizations for low-precision arithmetic. On devices without such specialized hardware, the quantization may be implemented using software techniques that balance accuracy and computational efficiency.

At 714, system 200 may update classifier performance metrics for future selection on each device type and device capabilities. The classification server 208 may collect feedback on the performance of the quantized layer, such as inference time, energy consumption, and output accuracy. This feedback may be used to refine the classifier selection process and improve the accuracy of quantization predictions for future queries.

The performance metric update may involve techniques such as online learning or periodic retraining of the classifiers. The classification server 208 may maintain a historical database of performance data for different device types and quantization decisions. This data may be analyzed to identify trends and patterns that can inform future classifier selections and quantization strategies. For example, if a particular classifier consistently underperforms for a specific device type, the system 200 may trigger a retraining process or adjust the classifier selection criteria to improve overall performance.

System 200 may use various algorithms to achieve its goal. For example, at 702, the system may employ unsupervised learning techniques such as k-means clustering or hierarchical clustering to group devices based on their capabilities. Feature extraction methods like principal component analysis (PCA) or t-SNE may be used to reduce the dimensionality of device metadata and identify key characteristics for clustering. At 704, the system may utilize transfer learning techniques such as fine-tuning or domain adaptation to train specialized classifiers for each device cluster. Techniques like gradient-based meta-learning or model-agnostic meta-learning (MAML) may be employed to create base models that can quickly adapt to specific device categories.

At 706, system processing may involve data preprocessing techniques such as normalization, standardization, or feature scaling to prepare the input data and layer outputs for classification. Natural language processing techniques like tokenization, embedding, or semantic analysis may be applied to analyze the complexity of user queries. At 708, the system may use a decision tree or a neural network-based selector to choose the appropriate classifier based on device metadata. This selector may be trained using techniques like reinforcement learning to optimize classifier selection over time. At 710, the system may employ ensemble methods such as random forests, gradient boosting machines, or deep neural networks to predict quantization levels. These models may be trained using techniques like cross-validation and hyperparameter optimization to ensure robust performance across different device types. At 712, system processing may involve dynamic computational graph manipulation or just-in-time compilation techniques to apply the predicted quantization levels efficiently. Hardware-specific optimizations, such as using vendor-provided libraries for quantized operations, may be employed to maximize performance on different devices. At 714, the system may use online learning algorithms like stochastic gradient descent or adaptive moment estimation (Adam) to update classifier performance metrics in real-time. Techniques like Thompson sampling or upper confidence bound (UCB) algorithms may be used to balance exploration and exploitation in classifier selection.

In the context of the tax preparation software use case, at 702, system processing may involve categorizing user devices based on their ability to handle complex tax calculations. High-performance devices capable of running sophisticated tax optimization algorithms may be grouped together, while devices suited for basic tax filing may form another cluster. At 704, the system may train separate classifiers for these device categories, with one classifier specializing in predicting quantization levels for complex corporate tax calculations and another focusing on optimizing performance for individual tax returns on lower-end devices.

In this use case, at 706, system processing may involve receiving and preprocessing tax-related queries and the output of tax calculation layers. For example, the system may analyze the complexity of a query about international tax laws or the dimensionality of outputs from a layer calculating deductions. At 708, the system may select a classifier trained specifically for high-performance devices when a user is performing complex business tax calculations on a powerful workstation. At 710, the system may predict that higher precision is beneficial for layers handling intricate tax credit calculations, while lower precision suffices for basic income summation. At 712, the system may apply these quantization levels, perhaps using 16-bit precision for a layer calculating foreign tax credits and 8-bit precision for a layer handling standard deductions. At 714, the system may update the performance metrics of these tax-specific classifiers, tracking how well they predict quantization levels for various tax calculation tasks across different device types and tax scenarios.

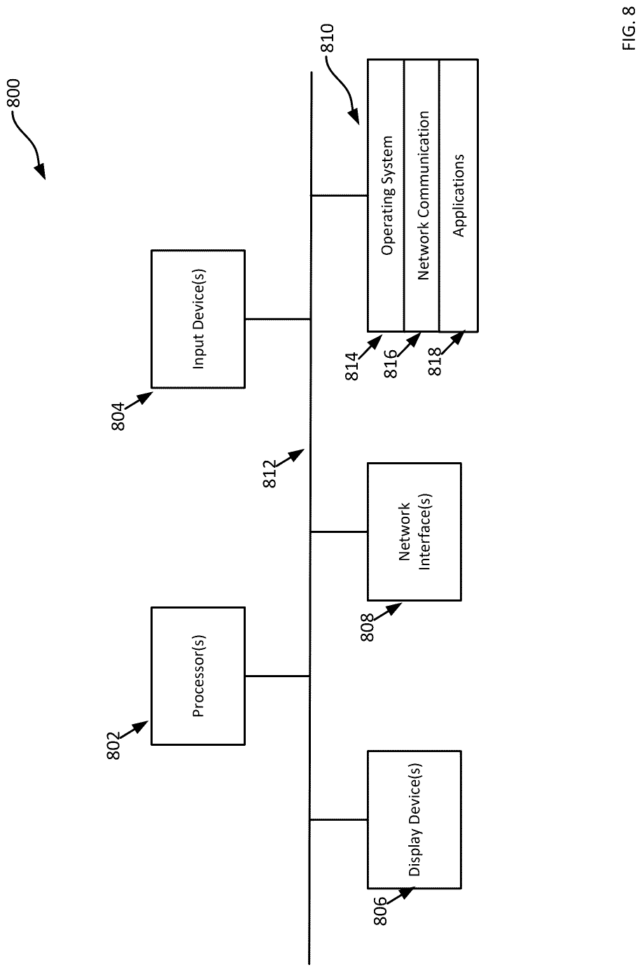

FIG. 8 illustrates a block diagram of a computing system 800 that may be used to implement dynamic layer quantization in an LLM. The system 800 may include several components interconnected via a system bus 812, which may serve as the central communication pathway allowing data and control signals to be exchanged between the various components.

A processor 802 may be connected to the system bus 812. The processor 802 may be responsible for executing instructions and performing computations necessary for dynamic layer quantization. In some cases, the processor 802 may be a multi-core processor capable of parallel processing, which may be particularly useful for handling the complex calculations involved in LLM operations and quantization decisions.

An input device 804 may also be connected to the system bus 812. The input device 804 may allow for user input to be received by the system 800. In the context of dynamic layer quantization, the input device 804 may be used to input queries or commands that initiate the LLM processing. For example, a user may type a question into a keyboard or speak a command into a microphone, both of which may be forms of the input device 804.

A display device 806 may be connected to the system bus 812 and may be used to provide visual output to a user. In the context of an LLM with dynamic layer quantization, the display device 806 may show the results of processed queries, system status information, or visualizations of the quantization process. For instance, the display device 806 may show a real-time graph of layer precision levels as they are dynamically adjusted during query processing.

A network interface 808 may also be connected to the system bus 812, enabling the system 800 to communicate with external networks or devices. The network interface 808 may be beneficial for implementing federated learning and distributed processing in dynamic layer quantization. It may allow the system 800 to send and receive model updates, quantization parameters, and processed queries between the user device 202 and the classification server 208.

The system 800 may also include a software stack 810, which may be depicted as being connected to the system bus 812. The software stack 810 may comprise multiple layers of software components that work together to implement dynamic layer quantization. At the base of the software stack 810 may be an operating system 814, which may manage the hardware resources and provide basic services to other software components.

Above the operating system 814 may be a network communication layer 816, which may handle network-related operations. This layer may be responsible for managing the communication protocols used in federated learning and distributed processing of the LLM. It may ensure secure and efficient transmission of model updates and quantization parameters between devices.

At the top of the software stack 810 may be an applications layer 818, which may include various user applications that can run on the system 800. In the context of dynamic layer quantization, this layer may include the LLM application, the quantization classifier, and any user interfaces for interacting with the system.

The system 800 may use a balanced local and global update algorithm to determine the balance between local model updates and global aggregation. This algorithm may be implemented across various components of the system 800. The processor 802 may execute the algorithm, using data received through the network interface 808 and stored in memory (not shown in the figure). The algorithm may analyze local update data from the user device 202 and global model data from the classification server 208 to determine the optimal balance for updating the LLM.

In a use case example, consider a distributed language translation system using dynamic layer quantization. A user may input a sentence to be translated using the input device 804 of their local system 800. The processor 802 may process this input through the locally stored LLM, dynamically adjusting layer quantization based on the complexity of the sentence and available system resources. The network interface 808 may then send the local model updates to a central server.

The central server, also implemented on a system 800, may receive updates from multiple user devices through its network interface 808. The processor 802 of the central server may then execute the balanced local and global update algorithm, determining how to aggregate these updates into the global model. This algorithm may consider factors such as the quantity and quality of data from each device, the current global model performance, and the diversity of language pairs being translated.

Once the global model is updated, the central server may use its network interface 808 to distribute the new model parameters and quantization strategies back to the user devices. The local system 800 may then update its LLM through the applications layer 818 of its software stack 810, potentially adjusting the quantization levels of different layers based on the global update.

Throughout this process, the display device 806 on both the user device and the central server may provide visualizations of the quantization process, model performance metrics, and translation results. This use case demonstrates how the various components of the system 800 may work together to implement dynamic layer quantization in a distributed, federated learning environment for language translation.

While the foregoing is directed to example embodiments described herein, other and further example embodiments may be devised without departing from the basic scope thereof. For example, aspects of the present disclosure (e.g., modules) may be implemented in hardware or software or a combination of hardware and software. One example embodiment described herein may be implemented as a program product for use with a computer system. The program(s) of the program product defines functions of the example embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid-state random-access memory) on which alterable information is stored. Such computer-readable storage media, when carrying computer-readable instructions that direct the functions of the disclosed example embodiments, are example embodiments of the present disclosure.

It will be appreciated by those skilled in the art that the preceding examples are not limiting. It is intended that permutations, enhancements, equivalents, and improvements thereto are apparent to those skilled in the art upon a reading of the specification and a study of the drawings are included within the true spirit and scope of the present disclosure. It is therefore intended that the following appended claims include such modifications, permutations, and equivalents as fall within the true spirit and scope of these teachings.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed:

1. A method for dynamic layer quantization in a language model, comprising:
receiving, at a classifier comprising at least one processor, query data from a user device and output data from a current layer of a large language model (LLM);
predicting, by the classifier, a quantization level for a subsequent layer of the LLM corresponding to the query data from the user device and output data from the current layer of the LLM;
selecting, by the classifier, the predicted quantization level for the subsequent layer of the LLM;
processing, by the LLM, the output data of from the current layer of the LLM through the quantized subsequent layer of the LLM; and
outputting, by the LLM, a response to the user query.

2. The method of claim 1, further comprising:
training, by the at least one processor, the classifier to predict the quantization levels for the subsequent layer of the LLM by comparing performance of the quantization levels against corresponding data of a full precision version of the LLM.

3. The method of claim 2, wherein training the classifier further comprises:
processing training data through each layer of the full precision LLM;
testing various quantization levels for the subsequent layer; and
selecting the quantization level that meets an output data accuracy threshold with respect to the full precision LLM.

4. The method of claim 1, wherein predicting the quantization level further comprises:
selecting from a set of predefined quantization levels including full precision, FP16, int8, and int4.

5. The method of claim 1, further comprising:
monitoring, by the at least one processor, device performance and resource utilization; and
adjusting, by the at least one processor, the predicted quantization level in response to determining changes in device capabilities or workload.

6. The method of claim 5, wherein adjusting the predicted quantization level further comprises:
evaluating current quantization levels against performance metrics;
determining new quantization levels for affected layers; and
updating quantization classifiers with new device information.

7. The method of claim 1, further comprising:
initializing, by the at least one processor, a global classifier model on a central server;
distributing, by the at least one processor, quantized model versions to edge devices;
training, by the at least one processor, the quantized model versions on the edge devices using local data; and
aggregating, by the at least one processor, the quantized model versions updates to refine the global model.

8. The method of claim 7, further comprising:
evaluating, by the at least one processor, global model performance and convergence; and
updating, by the at least one processor, quantization strategies that achieve the global performance.

9. The method of claim 1, further comprising:
sorting, by the at least one processor, input data correlated to device types and capabilities;
training, by the at least one processor, separate classifiers for different types of devices and device capabilities; and
selecting, by the at least one processor, an appropriate classifier correlated with a specific device type and device capabilities.

10. The method of claim 9, further comprising:
updating classifier performance metrics for future selection in response to determining each device type and device capabilities.

11. A system for dynamic layer quantization in a language model, comprising:
a classifier comprising at least one processor, the classifier configured to:
receive query data from a user device and output data from a current layer of a large language model (LLM);
predict a quantization level for a subsequent layer of the LLM corresponding to the query data from the user device and output data from the current layer of the LLM;
select the predicted quantization level for the subsequent layer of the LLM;
the LLM configured to:
process the output data from the current layer of the LLM through the quantized subsequent layer of the LLM; and
output a response to the user query.

12. The system of claim 11, wherein the classifier is further configured to train to predict the quantization levels for the subsequent layer of the LLM by comparing performance of the quantization levels against corresponding data of a full precision version of the LLM.

13. The system of claim 12, wherein the classifier is further configured to:
process training data through each layer of the full precision LLM;
test various quantization levels for the subsequent layer; and
select the quantization level that meets an output data accuracy threshold with respect to the full precision LLM.

14. The system of claim 11, wherein the classifier is further configured to:
select from a set of predefined quantization levels including full precision, FP16, int8, and int4.

15. The system of claim 11, wherein the classifier is further configured to:
monitor device performance and resource utilization; and
adjust the predicted quantization level in response to determining changes in device capabilities or workload.

16. The system of claim 15, wherein the classifier is further configured to:
evaluate current quantization levels against performance metrics;
determine new quantization levels for affected layers; and
update quantization classifiers with new device information.

17. The system of claim 11, wherein the classifier is further configured to:
initialize a global classifier model;
distribute quantized model versions;
aggregate the quantized model versions updates to refine the global model.

18. The system of claim 17, wherein the classifier is further configured to:
evaluate global model performance and convergence; and
update quantization strategies to achieve the global performance.

19. The system of claim 11, wherein the classifier is further configured to:
sort input data correlated to device types and capabilities;
train separate classifiers for different types of devices and device capabilities; and
select an appropriate classifier correlated with a specific device type and device capabilities.

20. The system of claim 19, wherein the classifier is further configured to:
update classifier performance metrics for future selection in response to determining each device type and device capabilities.
